(19) United States
(12) Patent Application Publication
(10) Pub. No.: US 2017/0061484 A1
(43) Pub. Date: Mar. 2, 2017

(54) METHOD FOR DETERMINING NEXT PURCHASE INTERVAL FOR CUSTOMER AND SYSTEM THEREOF

(71) Applicant: MIGO Corporation, New Taipei City (TW)

(72) Inventors: Chia-Chi Jen, New Taipei City (TW); Meng-Shiun Wu, Taichung City (TW)

(21) Appl. No.: 15/252,170

(22) Filed: Aug. 30, 2016

Related U.S. Application Data
(60) Provisional application No. 62/211,890, filed on Aug. 31, 2015.

(51) Int. Cl. G06Q 30/02

(52) U.S. Cl. CPC G06Q 30/0255; G06Q 30/0201; G06Q 30/0269; G06Q 30/0205

(57) ABSTRACT

A method for determining a next purchase interval of a customer is disclosed. A plurality of customer purchase records with customer identities, purchase dates, purchase intervals and purchase locations are collected. The plurality of customer purchase records are classified into individual and group purchase behaviors based on each of the purchase locations. An individual weight for the individual purchase behavior and a group weight for the group purchase behavior are calculated by Bayesian modeling. An individual purchase behavior variable based on the individual purchase behavior is generated. A group purchase behavior variable based on the group purchase behavior is generated. A next purchase interval for the customer at each of the purchase locations is determined by close form calculation using the individual weight, the individual purchase behavior variable, the group weight, and the group purchase behavior variable as inputs.

### CROSS REFERENCE TO RELATED APPLICATION

The present application claims priority to U.S. Provisional Application Ser. No. 62/211,890 filed on Aug. 31, 2015, titled in “Method of Next Purchasing Time Mechanism”, which is hereby incorporated by reference in its entirety.

### FIELD

The present disclosure is directed to a method of digital marketing, and more specifically to a method of improving the accuracy of determining the next purchase interval (or time) and a system thereof.

### BACKGROUND

Engaging customers at the right time is essential for digital marketing. Effect of marketing will be impaired if customers are not engaged at the right time, thereby reducing potential business opportunities.

### SUMMARY

The present disclosure includes a computer implemented method for determining a next purchase interval for a customer. A plurality of customer purchase records are collected. The plurality of customer purchase records include customer identities, purchase dates, purchase intervals and purchase locations. The plurality of customer purchase records are then classified into an individual purchase behavior and a group purchase behavior based on each of the purchase locations. An individual weight for the individual purchase behavior and a group weight for the group purchase behavior are calculated using Bayesian model. An individual purchase behavior variable is generated based on the individual purchase behavior. A group purchase behavior variable is generated based on the group purchase behavior. A next purchase interval for the customer at each of the purchase locations is determined by close form calculation using the individual purchase behavior variable, the individual weight, the group weight, and the group purchase behavior variable as inputs. Finally, the determined next purchase interval for the customer at each of the purchase locations is transmitted to a system for engaging real-world purchase activity.

In one embodiment, the present disclosure further includes grouping the plurality of customer purchase records according to the proximity of the purchase locations. Next, classifying the grouped customer purchase records into an individual proximity location behavior and a group proximity location behavior. Using Bayesian modeling, an individual proximity weight for the individual proximity location behavior and a group proximity weight for the group proximity location behavior is calculated. Further, generating an individual proximity location behavior variable based the individual proximity location behavior. Generating a group proximity location behavior variable based on the group proximity location behavior. Finally, determining a next purchase interval for the customer at each proximity of the purchase locations by close form calculation using the individual proximity location behavior variable, the individual proximity weight, the group proximity weight, and the group proximity location behavior variable as inputs.

In one embodiment, the present disclosure includes a computer implemented method for determining a next purchase interval for a customer. A plurality of customer purchase records are collected. The plurality of customer purchase records include customer identities, purchase dates, purchase intervals and product identities. The plurality of customer purchase records is classified into an individual purchase behavior and a group purchase behavior based on each of the product identities. Using Bayesian modeling, an individual weight for the individual purchase behavior and a group weight for the group purchase behavior is calculated. An individual purchase behavior variable is generated based on the individual purchase behavior. A group purchase behavior variable is generated based on the group purchase behavior. The individual purchase behavior variable, the individual weight, the group weight, and the group purchase behavior variable are used as inputs to a close form. A next purchase interval for the customer for each of the product identities is determined by the foregoing close form calculation. The determined next purchase interval is transmitted to a system for the customer for each of the product identities for engaging real-world purchase activity.

In another embodiment, the present disclosure includes a hardware memory storing computer-executable means for determining a next purchase interval for a customer and hardware processor for executing the computer-executable means stored in the hardware memory. From a hardware storage device, a plurality of customer purchase records including customer identities, purchase dates, purchase intervals and purchase locations is collected. The plurality of customer purchase records is classified into an individual purchase behavior and a group purchase behavior based on each of the purchase locations. An individual weight for the individual purchase behavior and a group weight for the group purchase behavior is calculated using Bayesian model. An individual purchase behavior variable based on the individual purchase behavior is generated. A group purchase behavior variable based on the group purchase behavior is generated. The individual purchase behavior variable, the individual weight, the group weight, and the group purchase behavior variable are used as inputs to a close form. A next purchase interval for the customer at each of the purchase locations is determined by the foregoing close form calculation. The determined next purchase interval to an interface is transmitted.

### BRIEF DESCRIPTION OF THE DRAWINGS

FIG. 1 is a schematic of the system for determining the next purchase time according to an embodiment of the present disclosure.

FIG. 2 is a chart of the exemplary data according to an embodiment of the present disclosure.

FIG. 3 shows exemplary purchase records made in a channel where the channel is a store.

FIG. 4 shows exemplary purchase records made in a channel where the channel is a mall.

FIG. 5 shows exemplary purchase records made in a channel where the channel is a specific product.

FIG. 6 shows exemplary aggregation of data according to an embodiment of the present disclosure.

FIG. 7 shows exemplary data to be analyzed using an algorithm according to an embodiment of the present disclosure.

FIG. 8 shows exemplary system output for determining customers' purchasing interval status according to one embodiment of the present disclosure.

FIG. 9 shows exemplary hazard rate analysis according to one embodiment of the present disclosure.

FIG. 10 illustrates examples of hazard rate curve for different customers according to one embodiment of the present disclosure.

FIGS. 11 and 12 show exemplary mean absolute error and mean square error according to one embodiment of the present disclosure.

FIGS. 13 and 14 are flow charts illustrating the methods of determining a next purchase time for a customer according to one embodiment of the present disclosure.

### DETAILED DESCRIPTION OF THE DISCLOSURE

The present disclosure attempts to determine a proper time to effectively engage customers. It aims to predict a mean purchase interval (a.k.a., a next purchase interval) for a customer. A customer's mean purchase interval may differ in different purchasing locations. After determining the mean purchase interval, a next purchase time for the customer can be calculated based on his/her last purchase date.

According to an embodiment of the present disclosure, the method of determining the next purchase time includes the following steps (not necessarily in a chronological order):

Data input;

Data preparation;

Data analysis using algorithm;

Form Output; and

Verification.

A system of the present disclosure is designed to execute a method for determining the next purchase time. Specifically, the method can be implemented by one or more specifically designed software, computer-executable means, and/or hardware modules.

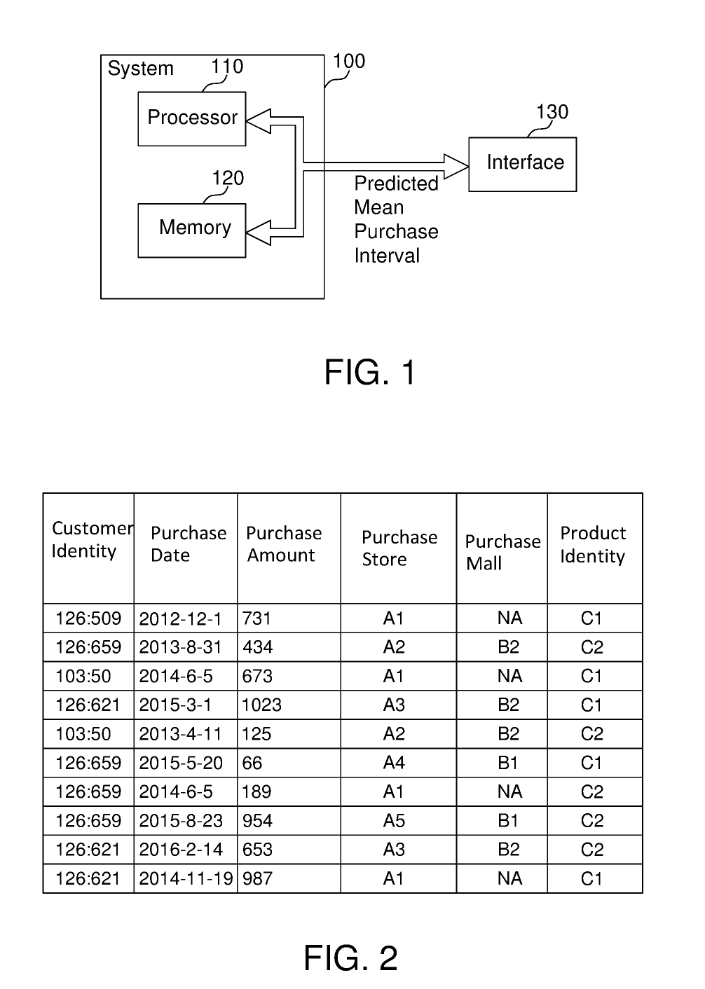

FIG. 1 illustrates the system 100 for determining a next purchase time according to an embodiment of the present disclosure. The system 100 may include a hardware processor 110 (e.g., CPU) and a hardware memory 120. The hardware memory 120 may store the computer-executable mean(s) for determining the next purchase time. The hardware processor 110 is configured to execute the computer-executable mean(s) stored in the hardware memory 120. Specifically, the hardware processor 110 is configured to calculate a customer's next purchase time based on the customer's mean purchase interval and last purchase date. The system 100 is connected to an interface 130, wired or wirelessly. The system 100 is configured to transmit customers' mean purchase interval, next purchase time and any relevant advertisement to the interface 130. Based on the next purchase time, the interface 130 may display selected advertisement at proper time to more effectively engage customers.

The following paragraphs are directed to the method executed by the system 100 according to a prefer embodiment.

Data Input

The system 100 requires the input of purchase behavior data. Such data may include:

Customer Identity

Every customer has a unique identity. The system 100 will analyze the customer's purchase behavior based on his/her identity.

Purchase Date and Purchase Interval

Every time an individual customer makes at least one purchase, the system 100 records the time/date of such purchase. The system 100 further calculates and records the time gaps/intervals between consecutive purchases.

Purchase Amount

Every time an individual customer makes at least one purchase, the system 100 records the amount of the purchase.

Purchase Location

Every time an individual customer makes at least one purchase, the system 100 records the location of the purchase.

Product Identity

Every time an individual customer makes at least one purchase, the system 100 records the identity of the product purchased.

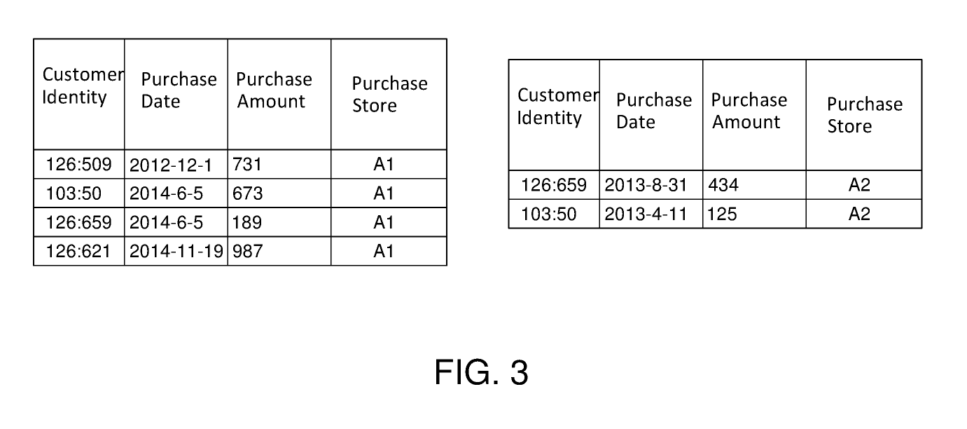

FIG. 2 is a chart of the exemplary data according to an embodiment of the present disclosure. The system 100 collects and records the customer identity (e.g. 103:50, 126:509, . . . etc.), purchase date, purchase amount, purchase locations (in stores and/or malls), product identity, and any other relevant purchase information in order to process them to determine the correct next purchase interval.

Data Preparation

A substantial amount of data is gathered by the system 100 from the “Data Input” stage. Such data relate to customer purchase behaviors in general. In this stage, the data are prepared and categorized in various fashions. An example is to organize the data into different categories: an individual purchase behavior and a group purchase behavior. In one embodiment, the system 100 is configured to prepare/organize the data as follows:

Data Cleaning

Because there may be unnecessary or redundant data collected during the “Data Input” stage, the system 100 first cleans and filters such data in order to expedite or simplify subsequent data processing. Unnecessary data may include redundant customer information or data recorded by unsolicited “channels”. The concept of “channel” will be discussed in detail in the following paragraph.

Segmentation by Channels

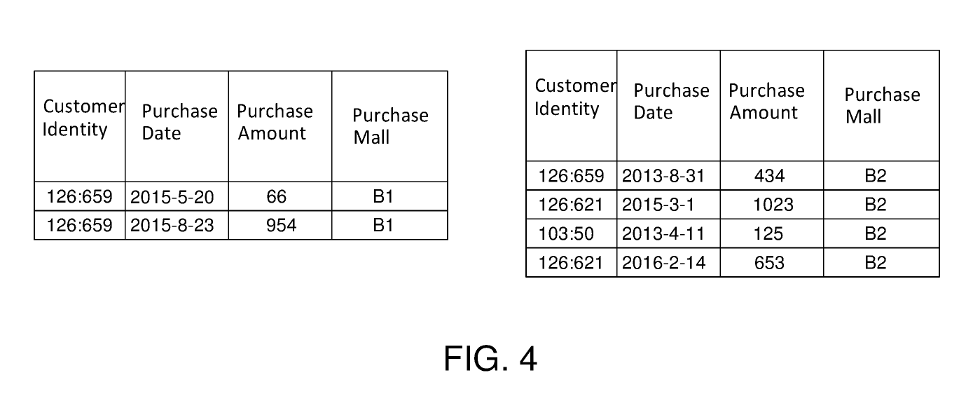

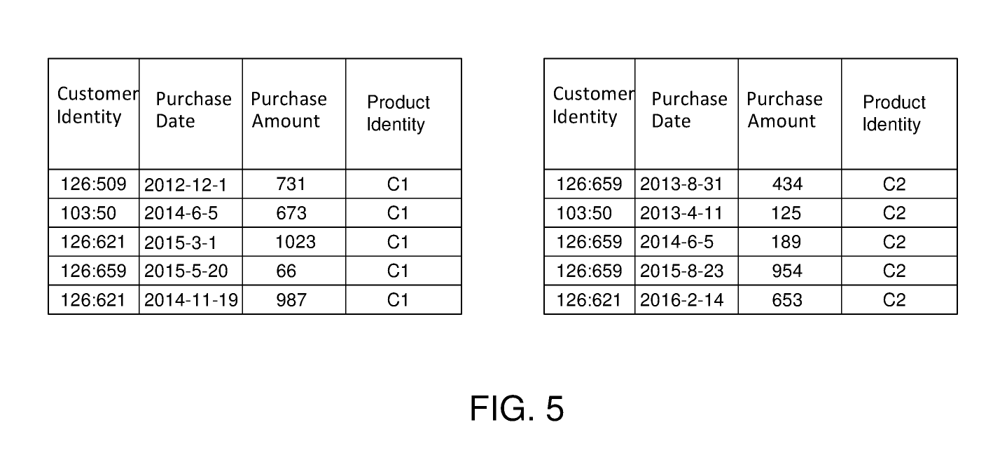

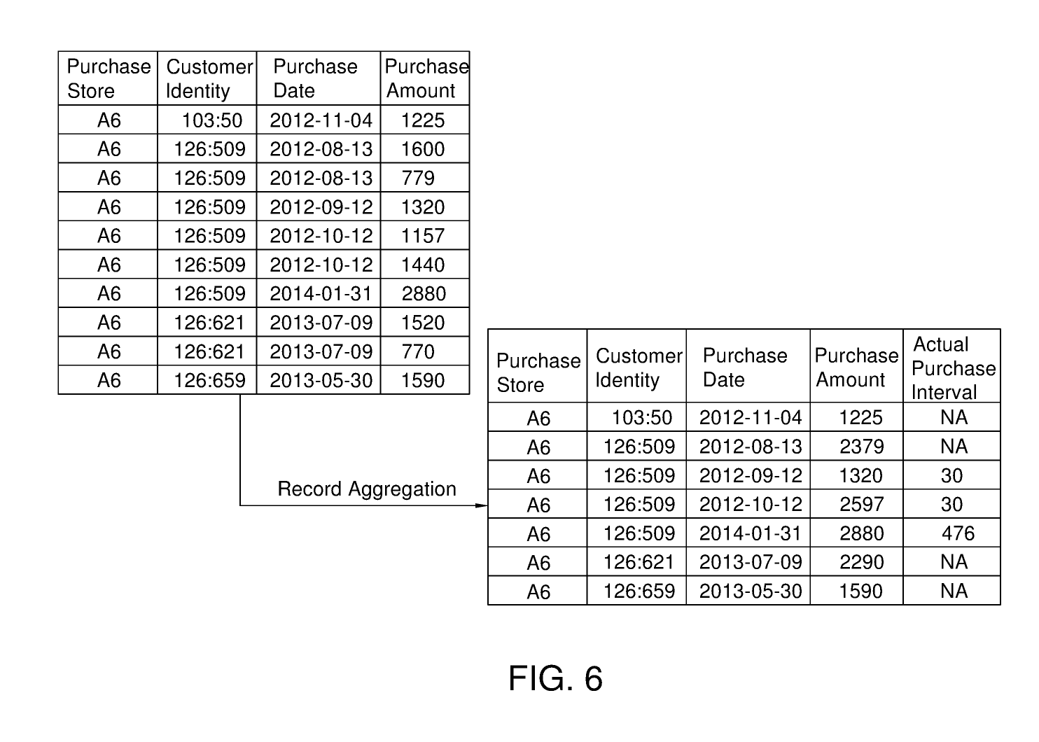

The system 100 can organize and combine the collected data into different channels. The system 100 then processes the data in each channel separately. Reference to FIG. 3, a “channel” may be defined as a single store/shop with a physical address or a URL. In this regard, all purchase activities that occurred in this single store/shop will be grouped into the same channel. In another example, a “channel” may be defined as a proximity of several stores/shops, e.g., a department store, a mall or a market place where there is a plurality of stores in close vicinity of each other, as referenced in FIG. 4. In this regard, all purchase activities that occurred in this proximity of stores/shops will be grouped into the same channel. In another example, a “channel” may be defined by a specific product regardless of the purchasing locations, as referenced in FIG. 5. In this regard, all purchase activities pertaining to this product will be grouped into the same channel.

Segmentation by channels allows the system 100 to more effectively identify consumers with similar purchase behavior and tendency, e.g., consumers within the same channel. Accordingly, customized and more accurate next purchase time analysis can be delivered to a single storeowner, a mall operator or a brand franchiser depending on the needs.

In one embodiment, the system 100 can provide a next purchase time analysis for each customer in a channel. The analysis may be carried out by classifying the data in channel into: (i) the purchase data representing the purchase behavior of an individual customer in such channel, and (ii) the purchase data representing the group purchase behavior of a group of customers in the same channel.

Aggregation Based on Customer Identity and Purchase Date

Because the system 100 may collect a vast amount purchase records, combining or aggregating some of the purchase records may facilitate subsequent data processing. In one example, repeated data of a same referential value may be aggregated. Specifically, the system 100 may combine all purchase records made by the same customer in the same day and in the same channel into one single record, thereby reducing the amount of records that need to be processed. The aggregation may also be applied to every customers in the same channel.

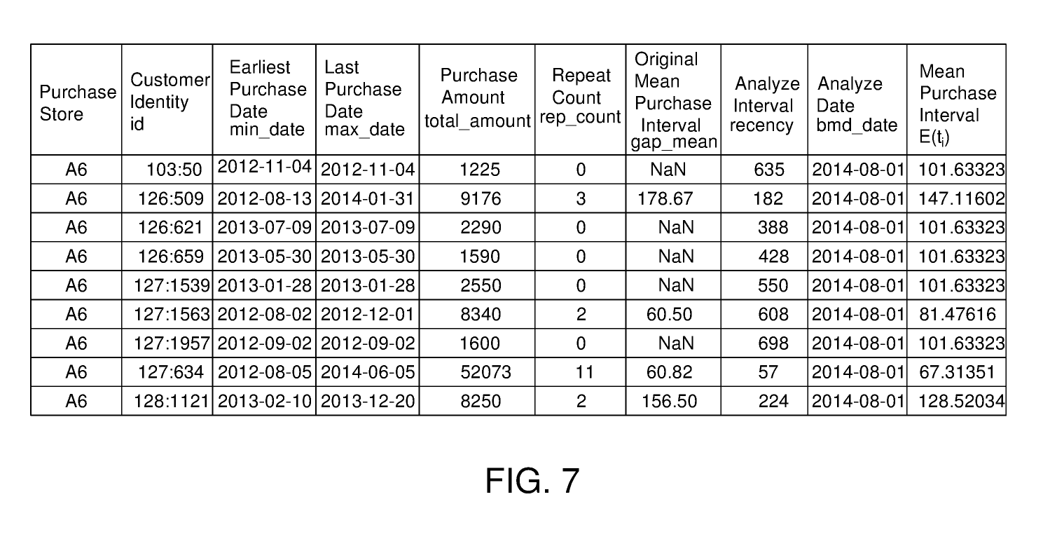

FIG. 6 illustrates an exemplary data aggregation based on customer identity and purchasing date. In the channel A6, which is a store, there are two purchase records for a customer identity 126:509 on Aug. 13, 2012, and two purchase records for a customer identity 126:621 on Jul. 9, 2013. The system 100 is configured to aggregate the customer's purchase records in the channel based on purchase date. As illustrated in FIG. 6, the two purchase records made by the customer identity 126:509 on Aug. 13, 2012 are combined, and the purchase amount for the two records add up to be 2379. Another two purchase records made by customer 126:509 on Oct. 12, 2012 are also combined, and the sum of the purchase amount for the two records is 2597. The same procedure is applied to the other purchase records made by customer 126:621 on Jul. 9, 2013. The purchase records are combined, and the sum of the purchase amount is 2290. After data aggregation, an “Actual Purchase Interval” is determined for each customer. For example, after the system 100 performs data aggregation, the customer identity 126:509 has four unique purchase records, each with a different purchase date. Actual purchase interval for the customer identity 126:509 are determined and shown on the right-most column (30 days between 2012 Aug. 13 to 2012 Sep. 12, 30 days between 2012 Sep. 12 to 2012 Oct. 12, and 476 days between 2012 Oct. 12 to 2014 Jan. 31).

Data Analysis by Algorithm

After the system 100 prepares the data collected at the “Data Input” stage, it next performs the following:

Calculation

The system 100 adjusts the data received from the “Data Preparation” stage by Bayesian Modeling. More particularly, the system 100 determines customer's mean purchase interval or next purchase interval based on an individual weight and a group weight generated through the application of Bayesian Modeling. Note that the individual weight and the group weight applies to records in the same channel. In one embodiment, if the channel is defined as a proximity of stores/shops, the individual weight for the channel is termed an individual proximity weight, and the group weight for the channel is termed a group proximity weight.

For a customer who made little or no purchase, the system 100 relies more on the purchase data of other customers in the same channel as the basis for calculating the mean purchase interval for such customer. Specifically, the system 100 may increase the group weight and decrease the individual weight when calculating the mean purchase interval. Based on established group purchase behaviors, the present disclosure may more accurately determine a correct purchase interval when the customer's actual purchase behavior is lacking or not available. In addition, as the number of data in the established purchase group increases, the accuracy improves.

Based on the same logic, when a customer accumulated a substantial number of purchase records in a channel, the system 100 will rely more on the customer's own purchase records when calculating the mean purchase interval. Specifically, the customer's individual weight is increased and the group weight is decreased.

In another embodiment, a standard Bayesian model can be used to calculate individual and group weights based on the customer behavior data in the same channel. One reason to apply a standard Bayesian model is to render the probability space for a customer at each different channel mutually-independent. For example, when determining the mean purchase interval for customer John, application of Bayesian model renders the probability space for John to buy at store A independent from the probability space for the same John to buy at store B. The application of mutually-independent probability spaces reduces the need to consider correlation between probability spaces of different data combination. Therefore, processing and calculation of data can be effectively simplified.

Input variables of the to-be-described close form calculations include an individual purchase behavior variable and a group purchase behavior variable. The individual purchase behavior variable is generated by the system 100 based on the individual purchase behavior in a channel. The group purchase behavior variable is generated by the system 100 based on the group purchase behavior in the same channel. In some embodiments, the individual purchase behavior variable includes an individual mean purchase interval. The group purchase behavior variable includes a group mean purchase interval.

Close Form Algorithm

The system 100 uses close form algorithm for simulation and calculation. The individual purchase behavior variable, the individual weight, the group purchase behavior variable and the group weight are used as inputs to the close form calculation in order to simulate a mean purchase interval. Applying close form can reduce calculation and allows simulation results to resemble more closely to the real statistics, i.e., the actual distribution of the input data. In one embodiment, the close form can be generated though a statistical distribution. The statistical distribution may be as a gamma distribution or an inverse gamma distribution.

In an embodiment of the present disclosure, the adjustment of the weights to determine the mean purchase interval (next purchase interval) of a customer may be achieved by implementing Bayesian model through the following formulas. A mean μ and a variance δ of the average purchase interval for all customers in the same channel need to be calculated. Further, a mean μ* and a variance δ* of the actual purchase interval for all customers in the same channel also need to be determined. They can be calculated by using the following formulas:

μ=mean(t̅₁̅,t̅₂̅,t̅₃̅, . . . ,tₗ) (1)

δ=var(t̅₁̅,t̅₂̅,t̅₃̅, . . . ,tₗ) (2)

μ*=mean(t₁₁,t₁₂,t₁₃, . . . ,tᵢⱼ) (3)

δ*=var(t₁₁,t₁₂,t₁₃, . . . ,tᵢⱼ) (4)

t̅₁̅, t̅₂̅, t̅₃̅, . . . , tₗ stands for the average purchase interval of each individual customer. For example, tₗ indicates the average purchase interval of the i-th individual customer in the channel. t₁₁, t₁₂, t₁₃, . . . , tᵢⱼ stands for the actual purchase interval of the customer. tᵢⱼ indicates an actual interval between the j-th purchase behavior and the (j+1)-th purchase behavior for the i-th individual customer. In addition, μ*mean(t₁₁, t₁₂, t₁₃, . . . , tᵢⱼ) represents a function to calculate a mean, and var ( ) represents a function to calculate a variance.

To generate an individual weight and a group weight for the customers in a channel, in addition to determining the mean μ, the variance δ, the mean μ*, and the variance δ*, three more derivative variables α, θ, and k are required and can be determined based on the following formulas:

$$\begin{matrix}α = \frac{{μ}^{2}}{δ} + 2 & ( 5 ) \\ θ = \frac{δ}{μ ( {μ}^{2} + δ )} & ( 6 ) \\ k = \frac{{( {μ}^{*} )}^{2}}{{δ}^{*}} & ( 7 )\end{matrix}$$

The individual weight w₁ and the group weight w₂ can be calculated according to the following formulas:

$$\begin{matrix}{w}_{1} = \frac{{kn}_{i}}{( {kn}_{i} + α - 1 )} & ( 8 ) \\ {w}_{2} = \frac{{μ}^{2} + δ}{δ ( {n}_{i} + \frac{α - 1}{k} )} & ( 9 )\end{matrix}$$

nᵢ stands for the number of repeated purchase or repeated purchase count for the i-th customer. In other words, nᵢ equals the total purchase count for the i-th customer minus one. According to the equations (8) and (9), when the number of repeated purchase nᵢ is small, i.e., when the i-th customer makes infrequent purchase in the channel, the individual weight w₁ will decrease while the group weight w₂ will increase. On the other hand, when the number of repeated purchase nᵢ is large, i.e., when the i-th customer makes a lot of repeated purchases in the channel, the individual weight w₁ will increase while the group weight w₂ will decrease.

A mean purchase interval E(tᵢ) for the i-th customer in the channel is calculated. The calculation is achieved by using variables determined in formulas (5)-(7) as inputs. The mean purchase interval E(tᵢ) is determined as follows:

$$E ( {t}_{i} ) = {w}_{1} \times \overline{{t}_{l}} + {w}_{2} \times μ = \frac{{kn}_{i}}{( {kn}_{i} + α - 1 )} \times \overline{{t}_{l}} + \frac{{μ}^{2} + δ}{δ ( {n}_{i} + \frac{α - 1}{k} )} \times mean ( \overline{{t}_{1}} , \overline{{t}_{2}} , \overline{{t}_{3}} , … , \overline{{t}_{l}} ) \qquad ( 10 )$$

As can be observed from the equation (10), while determining the mean purchase interval E(tᵢ) of the i-th customer, the average purchase interval tᵢ, i.e., the individual purchase behavior variable, is adjusted using the individual weight w₁. Moreover, the mean μ of the average purchase intervals for all customers in the same channel, i.e., the group purchase behavior variable, is adjusted using the group weight w₂.

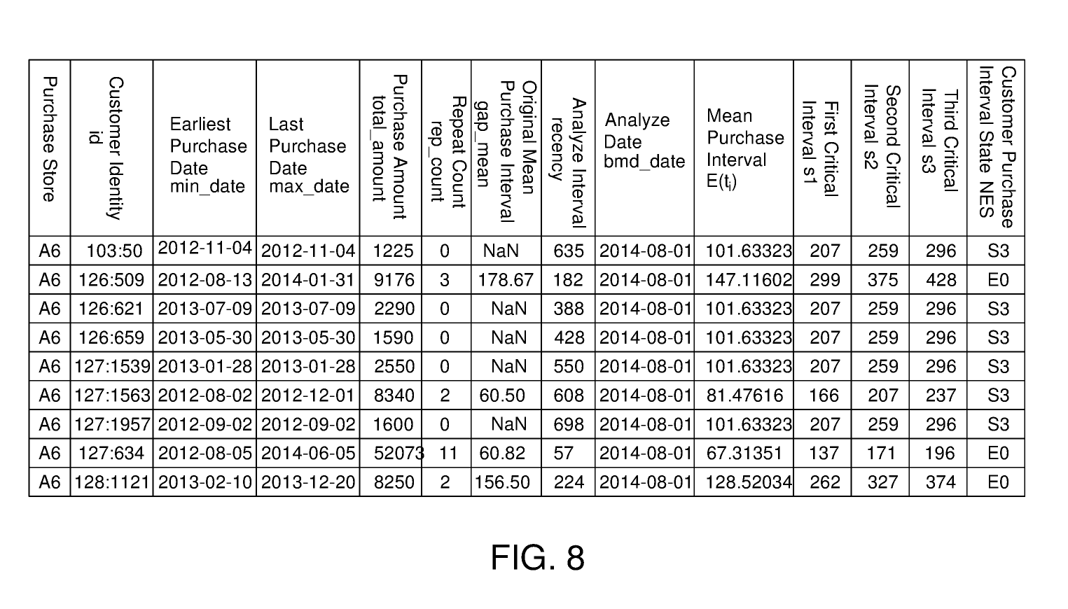

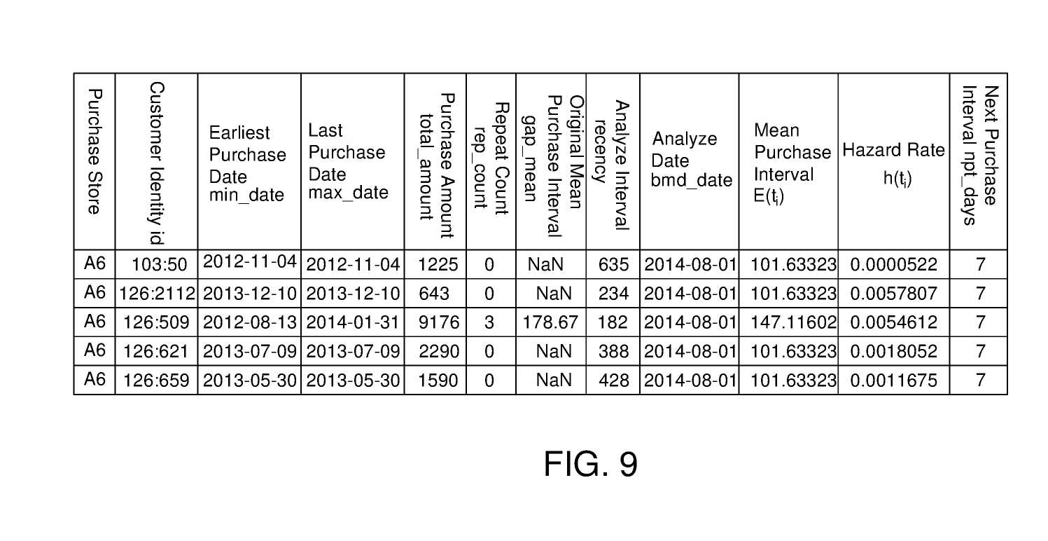

FIG. 7 shows the exemplary data to be analyzed using algorithm according to an embodiment of the present disclosure. The system 100 calculates the mean purchase interval E(tᵢ) for each customer identity in order to determine the next purchase time for each customer in channel A6. As illustrated, the system 100 records the following information for customers in the same channel: a purchase store or channel, a customer identity id, an earliest purchase date min_date, a last purchase date max_date, a purchase amount total_amount, a repeated purchase count rep_count, an original average purchase interval gap_mean, an analyze interval recency, an analyze date bmd_time, and the mean purchase interval E(tᵢ) determined by the system 100. Detailed definition of the above parameters will be explained in FIG. 8.

Form Output

After close form calculation, the system 100 acquires the following parameters, directly or indirectly.

Channel

The purchase records being analyzed should belong to the same channel, i.e., store A6.

Customer Identification

Each customer has a unique identity. Such identity will be the basis for analyzing the customer's ownership of each purchase record in the “Segmentation by Channels” stage.

Mean Purchase Interval

It is the customer's adjusted mean purchase interval determined at the “Analysis by Algorithm” stage.

Reference is made to the equation (10) to illustrate how to determine a customer's next purchase interval. The system 100 determines the mean purchase interval E(tᵢ) (assumed to be 6 days) via the equation (10) and also determines the customer's last purchase date in the channel (assumed to be 1^{st}, September). The system 100 then calculates the customer's next purchase date in the channel by adding the day counts represented by the mean purchase interval to the customer's last purchase date. In the present example, adding 6 days to September 1 will be September 7. The mean purchase interval E(tᵢ) can be calculated for an individual customer. For a group of customers in the same channel, same logic can be applied and a group average purchase interval for the group of customers can also be determined.

After the system 100 determines the mean purchase interval E(tᵢ) and the next purchase time of the i-th customer in a channel, the system 100 transmits the mean purchase interval E(tᵢ) and/or the next purchase time to an interface 130. A marketing system may work in conjunction with the interface 130 to more effectively engage the customer (e.g., the i-th customer). The marketing system may be operated by a single store owner, a mall operator or a franchiser. In one embodiment, the system 100 may select appropriate and relevant advertisement for the i-th customer according to the previous purchase records of the i-th customer. The multimedia advertisement may relate to specific products or categories of products. The marketing system may use a multimedia interface to engage the customer at the predicted next purchase date. The marketing system may also delegate real-world agent to engage the i-th customer at the predicted next purchase date. In another embodiment, the interface 130 may also receive previous purchase records, the calculated mean purchase interval E(tᵢ), and the last purchase date of the i-th customer in the channel from the system 100 to determine the appropriate engagement time.

Customer Purchase Interval State (i.e. New/Existing/Sleeper Customer Status)

In one embodiment of the present disclosure, the system 100 can identify every customer's activity status, i.e., purchase interval state, in the channel based on his/her mean purchase interval E(tᵢ) and last purchase date. The system 100 may select customers with specific activity status for marketing engagement. A customer purchase interval state can be classified as follows:
New customer status: customer who made his/her first purchase in a channel will be tagged as a new customer.
Existing customer status: customer who made repeated purchase within a maximal days determined according to the mean purchase interval E(tᵢ) will be tagged as an existing customer. The maximal days may equal to the mean purchase interval E(tᵢ), its multiples, or half plus its multiples. Alternatively, the maximal days may be adjusted dynamically according to the system's needs.
Sleeper customer status: customer who didn't make a repeated purchase within the maximum days, or whose purchase was made after the maximal day lapsed, will be tagged as a sleeper customer.

The acronym for customer purchase interval state is “NES state”, derived from the initial of the three statuses.

FIG. 8 shows exemplary system output for determining a plurality of customer purchasing interval state according to one embodiment of the present disclosure. The system 100 keeps track of the channel, the individual customer's identity id, the earliest purchase date min_date, the last purchase date max_date, the purchase amount total_amount, the repeated purchase account rep_count, the original average purchase interval gap_mean, the analyze interval recency, the analyze date bmd_time, the mean purchase interval E(tᵢ), the first critical interval s1, the second critical interval s2, the third critical interval s3 and the NES state. Note that the repeat count “rep_count” means total purchase count minus one. The original average purchase interval “gap_mean” means the average interval of a customer's actual purchase behavior. The analyze date “Bmd_time” means the date where the system 100 carries out the calculation in FIG. 8. The analyze interval “recency” means the analyze time “bmd_time” minus the customer's last purchase date max_date. The critical intervals s1, s2, and s3 represent the days after the last purchase date max_date in which the customer's non-appearance probability is 75%, 85%, and 95%. The probability in the present embodiment is not limited to specific numbers. The customers' purchase status (NES status) is determined based on the correlation between the critical intervals s1, s2, s3 and the different analyze intervals recency. The NES status represents the customer's activity status on the analyze date bmd_time.

Reference is now made to FIG. 8. For the customer identity 126:509, his/her earliest purchase date min_date is 2012 Aug. 13, his/her last purchase date max_date is 2014 Jan. 31, his/her purchase amount total_amount is 9176, there were a total of 4 purchases made at the channel from 2012 Aug. 13 to 2014 Jan. 31, and his/her repeated purchase count rep_count is (4−1)=3. The average purchase interval gap_mean is 178.67 days, which is calculated according to the three intervals reference in FIG. 6, which are 30 days, 30 days and 476 days. The analyze date bmd_date by the system 100 is 2014 Aug. 1, and therefore the analyze interval recency is 2014 Aug. 1 minus his/her last purchase date max_date of 2014 Jan. 31, i.e., 182 days. The first critical interval s1 of this customer is 299 days. It represents this customer's probability of not showing up again at the channel 299 days post his/her last purchase max_date is 75%. Similarly, the second critical interval s2 represents that the customer's probability of not showing up 375 days post his/her last purchase date max_date is 85%. The third critical interval s3 represents that the customer's probability of not showing up 428 days post his/her last purchase date max_date is 95%. Because the customer's analyze interval recency, which is 182 days, didn't exceed his/her first critical interval s1 (299 days), the customer's NES status is E0, meaning that customer identity 126:509 is tagged as an existing customers status.

Customers whose NES state are S1, S2, S3 mean they are in the sleeper customer status. A customer with the NES status S1 has his/her analyze interval recency between the critical intervals s1 and s2. A customer with the NES status S2 has his/her analyze interval recency between the critical intervals s2 and s3. A customer with the NES status S3 has his/her analyze interval recency exceeding the third critical interval s3. In short, for NES states, the order for the degree of activeness is E0>S1>S2>S3, where E0>s1 indicates that a customer with NES state E0 is more active, i.e., more purchasing activities, than a customer with the NES status S1.

The system 100 also focuses on individual customers having the existing customer status E0 to perform derivative calculation and analysis of the mean purchase interval E(tᵢ).

Next Purchase Hazard Rate

Next purchase hazard rate indicates the probability that the i-th customer purchases again in X-day after his/her last purchase date in the channel. X is a positive integer. In one embodiment, X may be 7 or 30, so that the system 100 may determine the hazard rate of the i-th customer weekly or monthly. Calculation of the next purchase hazard rate is based on a hazard rate function and the mean purchase interval E(tᵢ) is used as an input to the hazard rate function. By calculating the next purchase hazard rate, the system 100 may more effectively engage the i-th customer. Moreover, every time when the i-th customer makes purchases in the channel, the system 100 updates the corresponding mean purchase interval E(tᵢ) and next purchase hazard rate.

A half-normal distribution is assumed to be used on each customer's purchase behavior probability space. It is also used to calculate hazard rate. When calculating the hazard rate of a customer based on an equation (15) below, the denominator of the hazard rate is a probability that the individual customer has not initiated a purchase behavior before the analyze date bmd_date. That is, a 100% probability minus a cumulative probability function that accumulatively calculates the individual customer's purchase probability from his/her last purchase date max_date to the analyze date bmd_date. Similarly, the numerator of the hazard rate formula is a probability density function of the individual customer's purchase behavior on the analyze date bmd_date.

While calculating the hazard rate function, the i-th customer's purchase probability space is assumed to be Half Normal (0,σ²). In other words, the purchase interval for each customer is assumed to be 0 in the half normal distribution function Half Normal ( ) when calculating a corresponding variance σᵢ in advance. First, the mean purchase interval E(tᵢ) is calculated based on formula (11), and the time interval tᵢ indicates a time interval of the i-th customer from his/her last purchase date max_date to the analyze date bmd_date:

E(tᵢ)=k×E(λᵢ|tᵢⱼ)=σᵢ\sqrt{2}/\sqrt{π} (11)

Therefore, the variance σᵢ is calculated as follows:

σᵢ=E(tᵢ)×\sqrt{π}/\sqrt{2} (12)

While calculating the hazard rate function h(tᵢ), the above-mentioned denominator of the hazard rate function h(tᵢ) is:

$$1 - F ( {t}_{i} ) = 1 - ( 2 Φ ( \frac{{t}_{i}}{σ \sqrt{2}} ) - 1 ) = 2 - 2 Φ ( \frac{{t}_{i}}{σ \sqrt{2}} ) \qquad ( 13 )$$

F(tᵢ) indicates a cumulative probability that the i-th customer makes a purchase between his/her last purchase date max_date and the analyze date bmd_date.
Moreover, the numerator of the hazard rate function h(tᵢ) is calculated as follows:

$$f ( {t}_{i} ) = \frac{\sqrt{2}}{σ \sqrt{π}} {e}^{- \frac{{t}_{i}^{2}}{2 {σ}^{2}}} \qquad ( 14 )$$

Therefore, the hazard rate function h(tᵢ) is calculated as follows:

$$h ( {t}_{i} ) = \frac{f ( {t}_{i} )}{1 - F ( {t}_{i} )} = \frac{\frac{\sqrt{2}}{σ \sqrt{π}} {e}^{- \frac{{t}_{i}^{2}}{2 {σ}^{2}}}}{2 - 2 Φ ( \frac{{t}_{i}}{σ \sqrt{2}} )} \qquad ( 15 )$$

When the variance σᵢ is known, the hazard rate function h(tᵢ) is derived as a function of the time interval tᵢ. Different hazard rate curves may also be derived corresponding to different time intervals tᵢ.

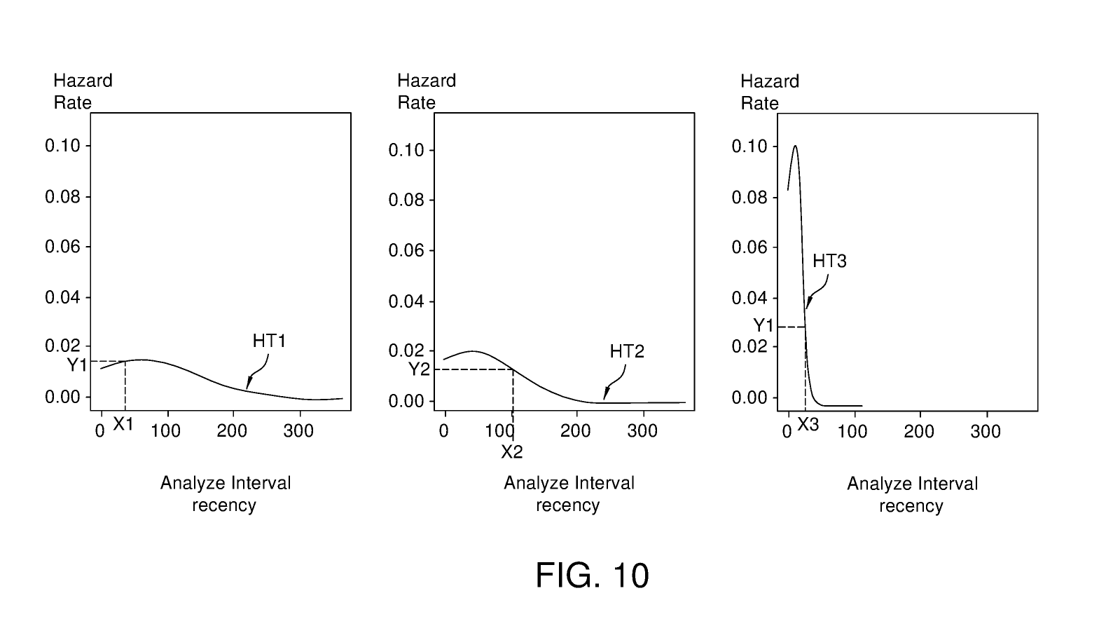

FIG. 9 shows exemplary hazard rate analysis according to one embodiment of the present disclosure. FIG. 9 illustrates the system 100 using the hazard rate function h(tᵢ) to evaluate the time to engage the i-th customer. When the system 100 uses the hazard rate function h(tᵢ) for evaluation, the system 100 may perform the following steps.

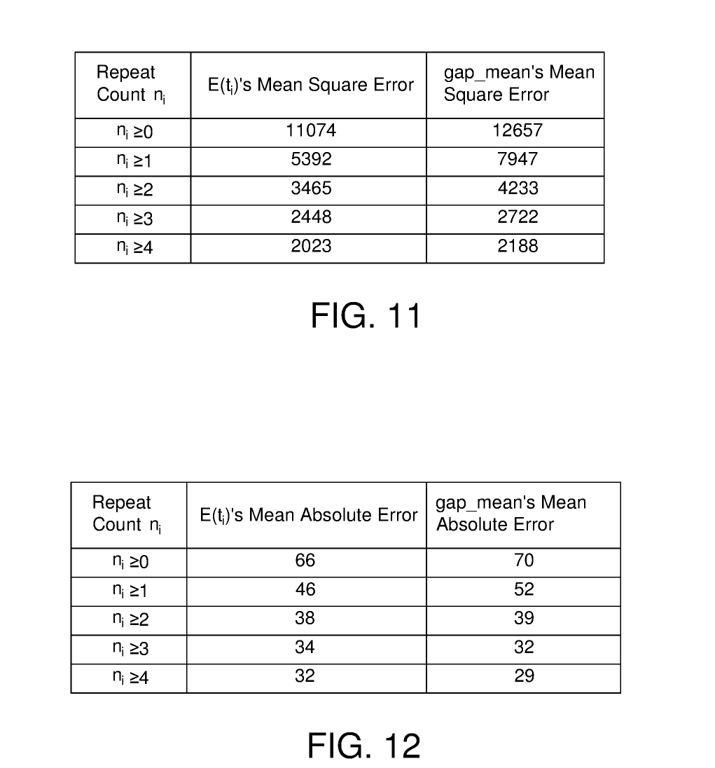

First, the system 100 may retrieve different hazard rate functions of time by using the hazard rate function h(tᵢ). For example, the hazard rate curves HT1, HT2 and HT3 shown in FIG. 10 indicate different hazard rate functions of time for three different customers. Among the hazard rate curves, the X-axis indicates the analyze interval recency, and the Y-axis indicates the hazard rate. After the system 100 determines hazard rate curves HT1, HT2 and HT3, the system 100 can assign the same analyze date bmd_date for all the three customers in the same channel. An exemplary analyze date bmd_date may be September 1st. The system 100 may also assign the same to-be analyzed date for all the three customers, for example, seven days, (i.e., the assigned next purchase interval npt_days in FIG. 9). Here, 7 days after September 1st is September 8th. Because the last purchase dates max_date of all the three customers may be different, their analyze intervals recency may also differ. In FIG. 10, the system 100 refers to the X-axis points X1, X2 and X3 that indicate the different analyze intervals recency of the three customers and adds an identical next purchase interval npt_days to them. Therefore, the system 100 can use the X-axis points X1, X2 and X3 and the hazard rate curves HT1, HT2 and HT3 to locate the corresponding hazard rates on the Y-axis points Y1, Y2 and Y3 on September 8th. With the aid of this mechanism, the system 100 can calculate the hazard rates for all customers in the same channel after the purchase interval npt_days of the assigned analyze date bmd_date. For example, the system 100 can calculate the hazard rates of all customers in the same channel on September 8th.

Second, after the system 100 assigns the specific date (e.g. September 8th) and calculates the hazard rates for all customers in the same channel, the system 100 can set a minimal hazard rate. Accordingly, the marketing system may only engage with customers having a higher hazard rate than the minimal hazard rate on the analyze date. The minimal hazard rate may be a minimal reasonable value that the system 100 determined according to the hazard rate statistics of all customers in the channel. For example, if the system 100 sets the minimal hazard rate to be 0.5, then the marketing system chooses customers who have higher rates than 0.5 to engage on the specific date. In other embodiment, the system 100 may also determine the minimal hazard rate based on the customers having top hazard rates. For example, if the system 100 only chooses customers with top one-thousand hazard rates to engage, the hazard rate of the customer who has the 1000^{th} or 1001^{th} rank of hazard rate is the minimal hazard rate for such specific date.

Verification

The system 100 verifies and adjusts the determined mean purchase interval E(tᵢ) every time a purchase occurs. With the verification step, the system 100 is capable of maintaining updated accuracy when calculating E(tᵢ). The verification steps are achieved pursuant to the following method:

Comparing Mean Purchase Interval E(tᵢ) and Actual Purchase Time

The present disclosure compares the mean purchase interval E(tᵢ) to an actual purchase time interval of the same customer in order to verify the system 100's accuracy for determining mean purchase interval E(tᵢ).

Correlation

The comparison between the mean purchase interval E(tᵢ) and the actual purchase interval will be used to determine the purchase interval status of the customer. If the customer is in the existing customer status, it suggests that the calculation of the mean purchase interval E(tᵢ) is highly accurate. Conversely, if the customer falls in the sleeping customers status, the system 100 will need to adjust the mean purchase interval E(tᵢ) of the customers. More specifically, upon a new purchase made by the customer, the system 100 updates its purchase record to renew the calculated mean purchase interval E(tᵢ). As such, the accuracy of calculation can be maintained. The correlation may be calculated according to the following equation:

$${r}_{( E ( t ) , y )} = \frac{{Σ}_{i = 1}^{n} ( E ( {t}_{i} ) - \overline{E ( t )} ) ( {y}_{i} - \overline{y} )}{\sqrt{{{Σ}_{i = 1}^{n} ( E ( {t}_{i} ) - \overline{E ( t )} )}^{2} {{Σ}_{i = 1}^{n} ( {y}_{i} - \overline{y} )}^{2}}} \qquad ( 16 )$$

E̅(̅t̅)̅ indicates the average expected value of all customers' mean purchase interval in a channel. yᵢ indicates the i-th customer's actual purchase interval between his/her last repeated purchases. y̅ indicates all customers' average actual purchase interval between the last repeated purchases. r_{(E(t),y)} refers to the correlation between the average purchase interval and the actual purchase interval of all customers in the same channel. It is also an index indicating the system 100's accuracy.

Other indexes for evaluating and improving the system's 100 accuracy are mean absolute error (MAE) and mean square error (MSE). The present disclosure will calculate the MAE and MSE after the mean purchase interval E(tᵢ) is determined. The equation for calculating the MSE and MAE of the mean purchase interval E(tᵢ) are as follows:

$$\begin{matrix}M S E ( E ( {t}_{i} ) ) = \frac{1}{n} {{Σ}_{i = 1}^{n} ( E ( {t}_{i} ) - \overline{E ( t )} )}^{2} & ( 17 ) \\ M A E ( E ( {t}_{i} ) ) = \frac{1}{n} {Σ}_{i = 1}^{n} \vert E ( {t}_{i} ) - \overline{E ( t )} \vert & ( 18 )\end{matrix}$$

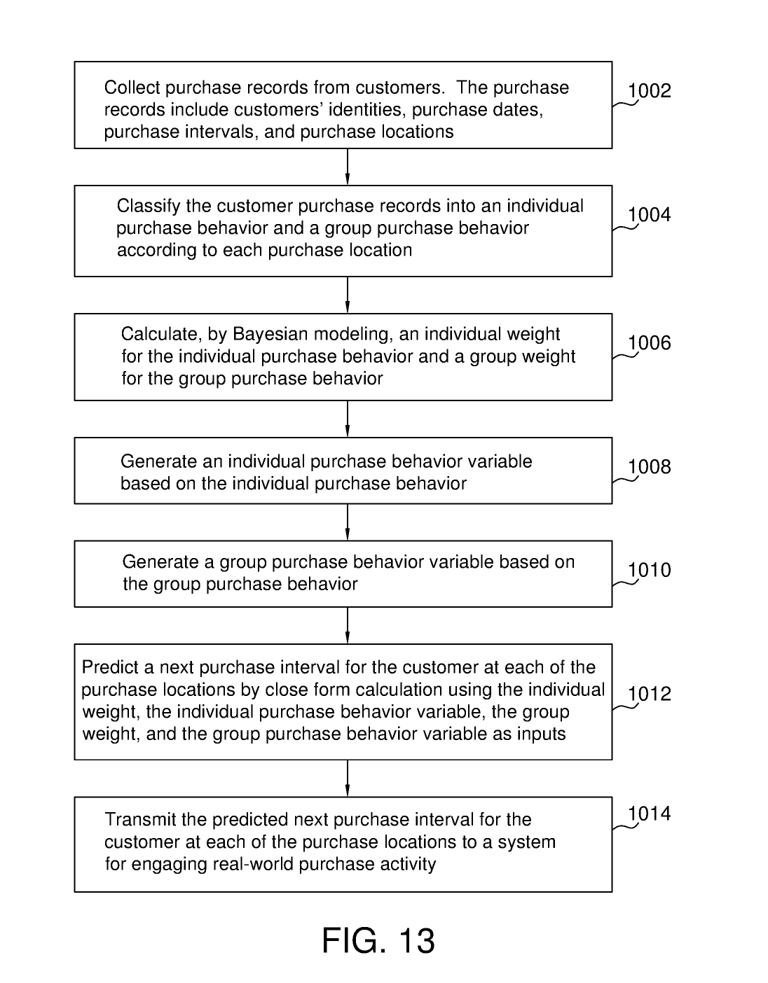

FIGS. 11 and 12 illustrate a simplified way of calculating the MSE and MAE of the mean purchase interval E(tᵢ). In one embodiment, the system 100 estimates the repeated purchase counts rep_count for every customer in the same channel and calculates the MAE of the mean purchase interval E(tᵢ). The resulting MAE is preferred to be small. The system 100 also calculates the MSE of the mean purchase interval E(tᵢ) in order to serve as a reference for altering the calculations of MAE and MSE if required. That is, if the resulting MAE or MSE is higher than an expectation value, such as the MAE or MSE of the original average purchase interval gap_mean shown in FIGS. 11 and 12, the system 100 will re-calculate the mean purchase interval E(tᵢ) again to see if the resulting MAE or MSE will be lowered.

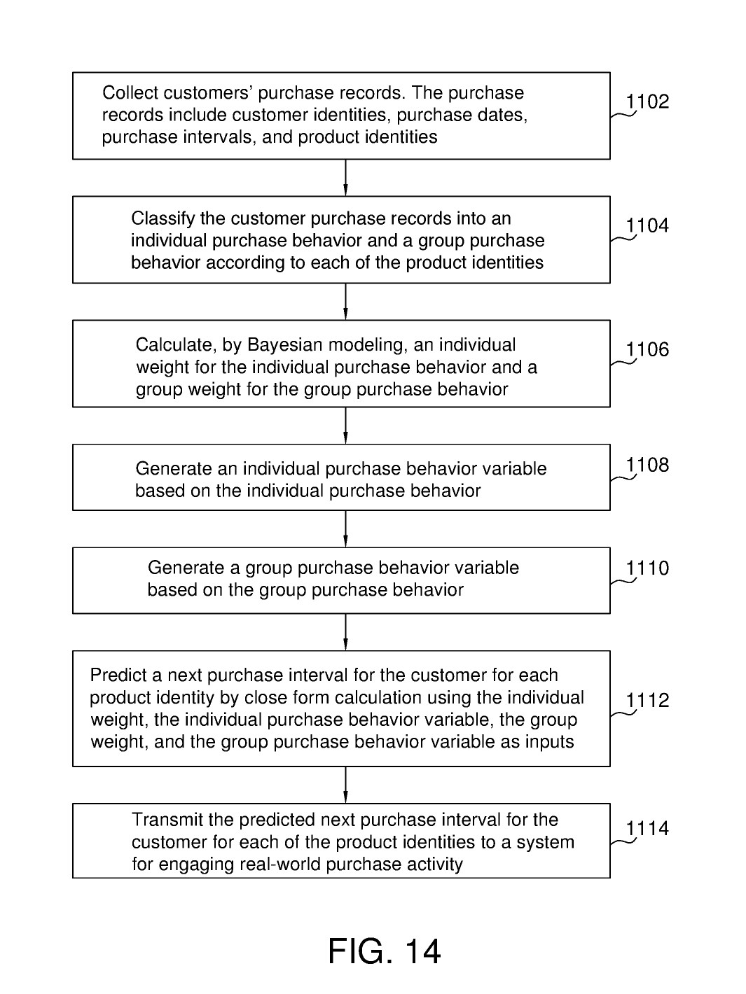

With reference to FIG. 13, the system 100 performs the following steps to determine the next purchase interval of a customer.

Step 1002: Collect purchase records from customers. The purchase records include customers' identities, purchase dates, purchase intervals, and purchase locations.

Step 1004: Classify the customer purchase records into an individual purchase behavior and a group purchase behavior according to each purchase location.

Step 1006: Calculate, by Bayesian modeling, an individual weight for the individual purchase behavior and a group weight for the group purchase behavior.

Step 1008: Generate an individual purchase behavior variable based on the individual purchase behavior.

Step 1010: Generate a group purchase behavior variable based on the group purchase behavior.

Step 1012: Determine a next purchase interval for the customer at each of the purchase locations by close form calculation using the individual weight, the individual purchase behavior variable, the group weight, and the group purchase behavior variable as inputs.

Step 1014: Transmit the determined next purchase interval for the customer at each of the purchase locations to a system for engaging real-world purchase activity.

With reference to FIG. 14, the system 100 performs the following steps so as to determine the next purchase interval of a customer:

Step 1102: Collect customers' purchase records. The purchase records include customer identities, purchase dates, purchase intervals, and product identities.

Step 1104: Classify the customer purchase records into an individual purchase behavior and a group purchase behavior based on each of the product identities.

Step 1106: Calculate, by Bayesian modeling, an individual weight for the individual purchase behavior and a group weight for the group purchase behavior.

Step 1108: Generate an individual purchase behavior variable based on the individual purchase behavior.

Step 1110: Generate a group purchase behavior variable based on the group purchase behavior.

Step 1112: Determine a next purchase interval for the customer for each product identity by close form calculation using the individual weight, the individual purchase behavior variable, the group weight, and the group purchase behavior variable as inputs.

Step 1114: Transmit the determined next purchase interval to a system for engaging real-world purchase activity.

It is to be noted that the steps in FIG. 13 and FIG. 14 may be stored as computer-executable means in the memory 120 and executed by the processor 110. In addition, FIG. 13 and FIG. 14 only illustrate certain embodiments of the present disclosure. Any foreseeable derivatives or changes to the embodiments of this specification should still be considered as within the scope of the present disclosure.

Person having ordinary skill in the art will perceive that, the present disclosure can be altered within the scope of the present disclosure. Conceivably, the specification aims to protect the claims within the scope of the present disclosure.

Furthermore, when describe the present disclosure, this specification aims at illustrate the means and procedures. However, the present disclosure doesn't confine to the certain steps specified in this specification. Person having ordinary skill in the art will understand that without following the present disclosure's steps and method, the present disclosure can also be executed by other procedures and methods. The orders of the steps can also be changed and altered without conflicting the main purpose and scope of the present disclosure.

1. A computer implemented method for determining a next purchase interval for a customer, comprising:
collecting a plurality of customer purchase records comprising customer identities, purchase dates, purchase intervals and purchase locations;
classifying the plurality of customer purchase records into an individual purchase behavior and a group purchase behavior based on each of the purchase locations;
calculating, by using Bayesian modeling, an individual weight for the individual purchase behavior and a group weight for the group purchase behavior;
generating an individual purchase behavior variable based on the individual purchase behavior;
generating a group purchase behavior variable based on the group purchase behavior;
determining a next purchase interval for the customer at each of the purchase locations by close form calculation using the individual purchase behavior variable, the individual weight, the group weight, and the group purchase behavior variable as inputs; and
transmitting the determined next purchase interval for the customer at each of the purchase locations to a system for engaging real-world purchase activity.

2. The method of claim 1 further comprising:
selecting at least one multimedia advertisement based on the individual purchase behavior; and
promoting the at least one multimedia advertisement at the determined next purchase interval after the customer's last purchase date at each of the purchase locations.

3. The method of claim 2, further comprising:
calculating a hazard rate by using the determined next purchase interval for the customer at each of the purchase locations as an input to a hazard rate function, wherein the hazard rate indicates the probability that a purchase activity occurs at a specific interval after the last purchase date;
selecting the at least one multimedia advertisement based on the individual purchase behavior; and
promoting the at least one multimedia advertisement at the specific interval when the hazard rate is higher than or equal to a minimal hazard rate.

4. The method of claim 1, further comprising:
comparing the determined next purchase interval with an actual next purchase interval of the customer at each of the purchase locations to determine a correlation between the determined next purchase interval and the actual next purchase interval; and
identifying an activity status for the customer at each of the purchase locations according to the determined correlation.

5. The method of claim 1, further comprising:
calculating a mean absolute error or a mean squared error according to the determined next purchase interval and an actual next purchase interval of the customer at each of the purchase locations; and
updating the determined next purchase interval for the customer at each of the purchase locations according to the calculated mean absolute error or the calculated mean squared error.

6. The method of claim 1, wherein the plurality of individual purchase behavior variables comprises a mean individual purchase interval.

7. The method of claim 1, wherein the group purchase behavior variable comprises a mean group purchase interval.

8. The method of claim 1, further comprising:
generating the close form using a statistical distribution.

9. The method of claim 8, wherein the step of generating the close form comprises generating the close form using a gamma distribution or an inverse gamma distribution.

10. The method of claim 1, wherein the step of calculating the individual weight and the group weight comprises calculating, by using Standard Bayesian Modeling, the individual weight for the individual purchase behavior and the group weight for the group purchase behavior.

11. The method of claim 1, further comprising:
grouping the plurality of customer purchase records according to proximity of the purchase locations;
wherein the step of classifying comprises: classifying the grouped customer purchase records into an individual proximity location behavior and a group proximity location behavior;
wherein the step of calculating comprises: calculating, by using Bayesian modeling, an individual proximity weight for the individual proximity location behavior and a group proximity weight for the group proximity location behavior;
wherein the step of generating the individual purchase behavior variable comprises:
generating an individual proximity location behavior variable based on the individual proximity location behavior;
wherein the step of generating the group purchase behavior variable comprises:
generating a group proximity location behavior variable based on the group proximity location behavior; and
wherein the step of determining comprises: determining a next purchase interval for the customer at each proximity of the purchase locations by close form calculation using the individual proximity location behavior variable, the individual proximity weight, the group proximity weight, and the group proximity location behavior variable as inputs.

12. A computer implemented method for determining a next purchase interval for a customer, comprising:
collecting a plurality of customer purchase records comprising customer identities, purchase dates, purchase intervals and product identities;
classifying the plurality of customer purchase records into an individual purchase behavior and a group purchase behavior based on each of the product identities;
calculating, by using Bayesian modeling, an individual weight for the individual purchase behavior and a group weight for the group purchase behavior;
generating an individual purchase behavior variable based on the individual purchase behavior;
generating a group purchase behavior variable based on the group purchase behavior;
determining a next purchase interval for the customer for each of the product identities by close form calculation using the individual purchase behavior variable, the individual weight, the group weight, and the group purchase behavior variable as inputs; and
transmitting the determined next purchase interval for the customer for each of the product identities to a system for engaging real-world purchase activity.

13. A system for determining a next purchase interval for a customer, the system comprising:
a hardware memory storing computer-executable means of:
collecting, from a hardware storage device, a plurality of customer purchase records comprising customer identities, purchase dates, purchase intervals and purchase locations;
classifying the plurality of customer purchase records into an individual purchase behavior and a group purchase behavior based on each of the purchase locations;
calculating, by using Bayesian modeling, an individual weight for the individual purchase behavior and a group weight for the group purchase behavior;
generating an individual purchase behavior variable based on the individual purchase behavior;
generating a group purchase behavior variable based on the group purchase behavior;
determining a next purchase interval for the customer at each of the purchase locations by close form calculation using the individual purchase behavior variable, the individual weight, the group weight, and the group purchase behavior variable as inputs; and
transmitting the determined next purchase interval to an interface; and
a hardware processor for executing the computer-executable means stored in the hardware memory.

14. The system of claim 13, wherein the hardware memory is further configured to store computer-executable means of:
grouping the plurality of customer purchase records according to the proximity of the purchase locations;
classifying the grouped customer purchase records into an individual proximity location behavior and a group proximity location behavior;
calculating, by using Bayesian modeling, an individual proximity weight for the individual proximity location behavior and a group proximity weight for the group proximity location behavior;
generating an individual proximity location behavior variable based on the individual proximity location behavior;
generating a group proximity location behavior variable based on and the group proximity location behavior; and
determining a next purchase interval for the customer at each proximity of the purchase locations by close form calculation using the individual proximity location behavior variable, the individual proximity weight, the group proximity weight, and the group proximity location behavior variable as inputs.

15. The system of claim 13, wherein the hardware memory is further configured to store computer-executable means of:
calculating a hazard rate by using the determined next purchase interval for the customer at each of the purchase locations as an input to a hazard rate function, wherein the hazard rate indicates the probability that a purchase activity occurs at a specific interval after the last purchase date;
selecting the at least one multimedia advertisement based on the individual purchase behavior; and
promoting the at least one multimedia advertisement at the specific interval when the hazard rate is higher than or equal to a minimal hazard rate.

16. The system of claim 13, wherein the hardware memory is further configured to store computer-executable means of:
comparing the determined next purchase interval with an actual next purchase interval of the customer at each of the purchase locations to determine a correlation between the determined next purchase interval and the actual next purchase interval; and
identifying an activity status for the customer at each of the purchase locations according to the determined correlation.

17. The system of claim 13, wherein the hardware memory is further configured to store computer-executable means of:
calculating a mean absolute error or a mean squared error according to the determined next purchase interval and an actual next purchase interval of the customer at each of the purchase locations; and
updating the determined next purchase interval for the customer at each of the purchase locations according to the calculated mean absolute error or the calculated mean squared error.
